(19) United States
(12) Patent Application Publication
(10) Pub. No.: US 2017/0068997 A1
(43) Pub. Date: Mar. 9, 2017

(54) ADVERTISEMENT DISTRIBUTION SYSTEM

(71) Applicant: SameClick, Co., Ltd., Minato-ku, Tokyo (JP)

(72) Inventor: Jun Kawakita, Tokyo (JP)

(73) Assignee: SameClick, Co., Ltd., Minato-ku, Tokyo (JP)

(21) Appl. No.: 15/123,312

(22) PCT Filed: Mar. 4, 2015
(86) PCT No.: PCT/JP2015/056301

§ 371 Date: Sep. 2, 2016

(30) Foreign Application Priority Data
Mar. 5, 2014 (JP) 2014-042390

(51) Int. Cl. G06Q 30/02; H04L 29/06; H04L 29/08

(52) U.S. Cl. CPC G06Q 30/0277; H04L 67/02; H04L 65/1069

(57) ABSTRACT

The purpose of the present invention is to provide an advertisement distribution system for distributing an advertisement corresponding to a web page being browsed by a user. Provided is an advertisement distribution system (1) having: an access destination information monitoring unit (50) for monitoring a state of access to a web server (2) by a user terminal (4) in a service providing computer (3) for providing an Internet service to the user terminal (4) and, upon detecting an access to the web server (2), acquiring access destination information and identification information about the user terminal; an advertisement storage unit (61) for storing the access destination information and advertisement information in correlation with each other; an advertisement specification processing unit (62) for specifying corresponding advertisement information from the advertisement storage unit (61) on the basis of the acquired access destination information; and an advertisement distribution processing unit (63) for distributing the specified advertisement information to the user terminal (4) on the basis of the acquired identification information about the user terminal and having the advertisement information displayed on the user terminal (4).

### TECHNICAL FIELD

The present invention relates to an advertisement distribution system for distributing an advertisement corresponding to a web page being browsed by a user.

### BACKGROUND ART

An advertisement is often inserted in a web page. Therefore, how to distribute an optimum advertisement to a user browsing the web page is a conventional issue. Therefore, there is an advertisement distribution system as described in the Patent Literatures 1 to 3.

Further, other than the Patent Literatures 1 to 3, for example, there is an advertisement distribution system called “AdWards” which displays an advertisement by linking to search engines (Non Patent Literature 1).

### CITATION LIST

### Patent Literature

Patent Literature 1: JP 2012-118866 A
Patent Literature 2: JP 2010-39600 A
Patent Literature 3: JP 2009-193498 A

### Non Patent Literature

Non Patent Literature 1: Google inc., “On-Line Advertisement Program in Google AdWords-Google” at URL:http://www.google.co.jp/intl/ja/adwords/how-it-works/ads-on-google.html

### SUMMARY OF INVENTION

### Technical Problem

According to Patent Literatures 1 to 3, when a user brows a web-page by a browser software (hereinafter called “a browser”), an advertisement is selected and displayed under a preset condition on an advertisement column of the web page. This condition is set, for example, such that an advertisement thought to be optimum is selected from a web-page browsing history of a user.

In this manner, an advertisement is displayed on an advertisement column of a web-page. Therefore, for example, when the advertisement column is not displayed on a display device since a user scrolls the web-page, the advertisement cannot be not displayed.

In addition, a website (web server) and an advertisement distribution server are linked, and an advertisement is displayed on a preset advertisement column on a web-page. Therefore, for example, on an advertisement column provided on a web-page of a car manufacture, advertisements of other competitive car manufactures are not displayed.

Further, in the case of Non Patent Literature 1, an advertisement is displayed on a search result page of a search engine, and therefore the advertisement is not displayed on any web-page.

In addition, in recent years, there is a system which enables browsing a same web-page while synchronizing multiple computers. However, a conventional advertisement system sets an advertisement to be distributed based on user's browsing history. Therefore, a different advertisement is displayed on each synchronized computer. Therefore, a system is desired which can display a same advertisement on multiple computers synchronizing a web page.

### Solution to Problem

An inventor of the present invention has disclosed an advertisement distribution system which can distribute an advertisement without linking a website (web server) and an advertisement distribution server.

A first invention is an advertisement distribution system. The advertisement distribution system distributes advertisement information to a user terminal being used by a user. The advertisement distribution system includes an access destination information monitoring unit, an advertisement storage unit, an advertisement specification processing unit, and an advertisement distribution processing unit. The access destination information monitoring unit monitors the state of access to a web server of the user terminal in a service providing computer to provide an Internet service to the user terminal and obtains access destination information and identification information of the user terminal when detecting access to the web server. The advertisement storage unit stores access destination information and advertisement information in association with each other. The advertisement specification processing unit specifies corresponding advertisement information from the advertisement storage unit based on the obtained access destination information. The advertisement distribution processing unit distributes the specified advertisement information to the user terminal and causes the user terminal to display the specified advertisement information based on the obtained identification information of the user terminal.

By configuring as described herein, an advertisement can be distributed to a user terminal without linking a web server and an advertisement distribution server. In addition, since a web server and an advertisement distribution server are not linked, advertisement conditions are not restricted by the web server. Therefore, an advertisement can be distributed under different conditions from a web page displayed by the web server. For example, an advertisement of a company can be displayed on a web page of a competitive company.

According to the above-described invention, in the advertisement distribution system, the user terminal includes a web page display processing unit and an advertisement display processing unit. The web page display processing unit displays information on a web page obtained from the web server. The advertisement display processing unit displays the distributed advertisement information by superimposing on the web page.

With a configuration according to the present invention, an advertisement is displayed upper than a web page. Therefore, an advertisement effect can be increased.

According to the above-described invention, in the advertisement distribution system, the advertisement display processing unit displays the advertisement information on a browser window independent from a browser window displaying information on the web page.

With a configuration according to the present invention, distributed advertisement information is displayed on a browser window independent from a browser window displaying a web page. Therefore, even if the web page is scrolled, the advertisement is still displayed, and an advertisement effect can be maintained.

A second invention is an advertisement distribution system distributing same advertisement information to each of synchronized user terminals when a plurality of user terminals displays a web page of a web server by synchronizing with each other. The advertisement distribution system includes a computer to provide synchronous processing, an access destination information monitoring unit, an advertisement storage unit, an advertisement specification processing unit, and an advertisement distribution processing unit. The computer to provide synchronous processing establishes a session between user terminals being used by users. The access destination information monitoring unit monitors the state of access to a web server of the user terminal in the computer to provide synchronous processing and obtains access destination information and identification information on each of the synchronized user terminals when detecting access to the web server. The advertisement storage unit stores access destination information and advertisement information in association with each other. The advertisement specification processing unit specifies corresponding advertisement information from the advertisement storage unit based on the obtained access destination information. The advertisement distribution processing unit distributes the specified advertisement information to each of the synchronized user terminals and causes the user terminals to display the specified advertisement information based on the obtained identification information of each of the user terminals.

There is a case where a web page is displayed by synchronizing the web page between user terminals being used by users. In such case, conventionally, displayed advertisements generally differ. Therefore, by performing processing as described herein, a same advertisement is displayed while displaying that the web page is synchronized.

According to the above-described invention, in the advertisement distribution system, the user terminal includes a synchronous processing unit, a temporary storage unit, a web page display processing unit, and an advertisement display processing unit. The synchronous processing unit performs synchronous processing of a web page between the user terminal and another user terminal by establishing a session with the computer to provide synchronous processing. The temporary storage unit stores information on the web page. The web page display processing unit displays the information on the web page stored in the temporary storage unit. The advertisement display processing unit displays the distributed advertisement information by superimposing on the web page.

A user terminal is preferably configured as described herein.

According to the above-described invention, in the advertisement distribution system, in the case where the user terminal is selected as a user terminal on a host side, when receiving a request to browse a web page which is not stored in the temporary storage unit, the synchronous processing unit obtains information on a web page corresponding to the browsing request from the web server and stores a part of or all of the information in the temporary storage unit. When a part of or all of the information on the web page is stored in the temporary storage unit, by sending a content update event to a user terminal on a remote side, the synchronous processing unit causes the user terminal on the remote side to obtain a part of or all of the information on the web page stored in the temporary storage unit and to display web page information between the user terminal on the host side and the user terminal on the remote side by synchronizing with each other.

According to the above-described invention, in the advertisement distribution system, in the case where the user terminal is selected as a user terminal on a remote side, when receiving a request to browse a web page which is not stored in a temporary storage unit on the remote side, the synchronous processing unit sends a request to browse the web page to a user terminal on a host side and causes the user terminal on the host side to determine whether information on the web page is stored in the temporary storage unit of the user terminal on the host side. If the information is not stored, the synchronous processing unit receives a content update event by causing the user terminal on the host sides to obtain information on a web page corresponding to the browsing request from the web server and to store the information in the temporary storage unit of the user terminal on the host side. When receiving the content update event, the synchronous processing unit obtains the information on the web page from the temporary storage unit of the user terminal on the host side and causes the temporary storage unit on the remote side to store the information.

Further, according to the above-described invention, in the advertisement distribution system, in a case where the user terminal is selected as a user terminal on a remote side, when receiving a request to browse a web page which is not stored in a temporary storage unit on the remote side, the synchronous processing unit sends a request to browse the web page to a user terminal on a host side and causes the user terminal on the host side to determine whether a part of the information on the web page is stored in the temporary storage unit of the user terminal on the host side, if the information is not stored, the synchronous processing unit receives a content update event by causing the user terminal on the host sides to obtain information on a web page corresponding to the browsing request from the web server and to store the information on a part of the web page in the temporary storage unit of the user terminal on the host side. When receiving the content update event, the synchronous processing unit obtains the information on a part of the web page from the temporary storage unit of the user terminal on the host side and causes the temporary storage unit on the remote side to store the information, and the synchronous processing unit obtains information other than the information on a part of the web page from the web server and causes the temporary storage unit on the remote side to store the information.

Although there are various methods for synchronous processing, according to the present invention, a user terminal on a host side accesses a web server, and information stored in a temporary storage unit of the user terminal on the host side is reflected to a user terminal on a remote side.

In addition, in the case where the synchronous processing is realized by transmitting information on URL being accessed between the user terminal on the host side and the user terminal on the remote side, the user terminals do not necessarily browse the same web page according to timing of accessing. However, as described herein, when the user terminal on the host side accesses a web page, and information on the web page is reflected to the user terminal on the remote side, display synchronization can be realized between the user terminal on the host side and the user terminal on the remote side.

The above-described advertisement distribution system is realized by performing a program according to the present invention by a computer. Specifically, in an advertisement distribution program, a computer functions as: an access destination information monitoring unit, an advertisement specification processing unit, and an advertisement distribution processing unit. The access destination information monitoring unit monitors the state of access to a web server of the user terminal in a service providing computer to provide an Internet service to a user terminal being used by a user and obtains access destination information and identification information of the user terminal when detecting access to the web server. The advertisement specification processing unit specifies corresponding advertisement information from an advertisement storage unit to store the access information and the advertisement information in association with each other based on the obtained access destination information. The advertisement distribution processing unit distributes the specified advertisement information to the user terminal and causes the user terminal to display the information based on the obtained identification information of the user terminal.

The above-described advertisement distribution system is realized by performing a program according to the present invention by a computer. Specifically, in the advertisement distribution program, a computer functions as an access destination information monitoring unit, an advertisement specification processing unit, and advertisement distribution processing unit. The access destination information monitoring unit monitors the state of access to a web server of the user terminal in a computer to provide synchronous processing for establishing a session between user terminals being used by users and obtains access destination information and identification information on each of the synchronized user terminals when detecting access to the web server. The advertisement specification processing unit specifies corresponding advertisement information from an advertisement storage unit to store the access information and the advertisement information in association with each other based on the obtained access destination information. The advertisement distribution processing unit distributes the specified advertisement information to each of the synchronized user terminals and causes the user terminal to display the information based on the obtained identification information of each user terminal.

### Advantageous Effects of Invention

With a configuration according to the present invention, even if a website (web server) and an advertisement distribution server are not linked, an advertisement can be distributed. Therefore, it is not necessary to integrate an advertisement column of a web page and an advertisement. Consequently, an advertisement can be distributed without being restricted by advertisement distribution conditions of a website and a web page. For example, on an advertisement column provided on a web page of a car manufacture, an advertisement of a competitive car manufacture can be displayed.

In addition, even in the case of using a system enabling browsing a same web page while synchronizing multiple computers, a same advertisement can be displayed in multiple computers.

### BRIEF DESCRIPTION OF DRAWINGS

FIG. 1 is a view schematically illustrating an example of a basic concept of an advertisement distribution system according to a first example.

FIG. 2 is a diagram schematically illustrating an example of a system configuration of the advertisement distribution system according to the first example.

FIG. 3 is a diagram schematically illustrating an example of a computer hardware.

FIG. 4 is a flowchart schematically illustrating an example of processing according to the present invention.

FIG. 5 is a diagram schematically illustrating an example of an advertisement storage unit.

FIG. 6 is a view schematically illustrating an example of a basic concept of an advertisement distribution system according to a second example.

FIG. 7 is a diagram schematically illustrating an example of a system configuration of the advertisement distribution system according to the second example.

### DESCRIPTION OF EMBODIMENTS

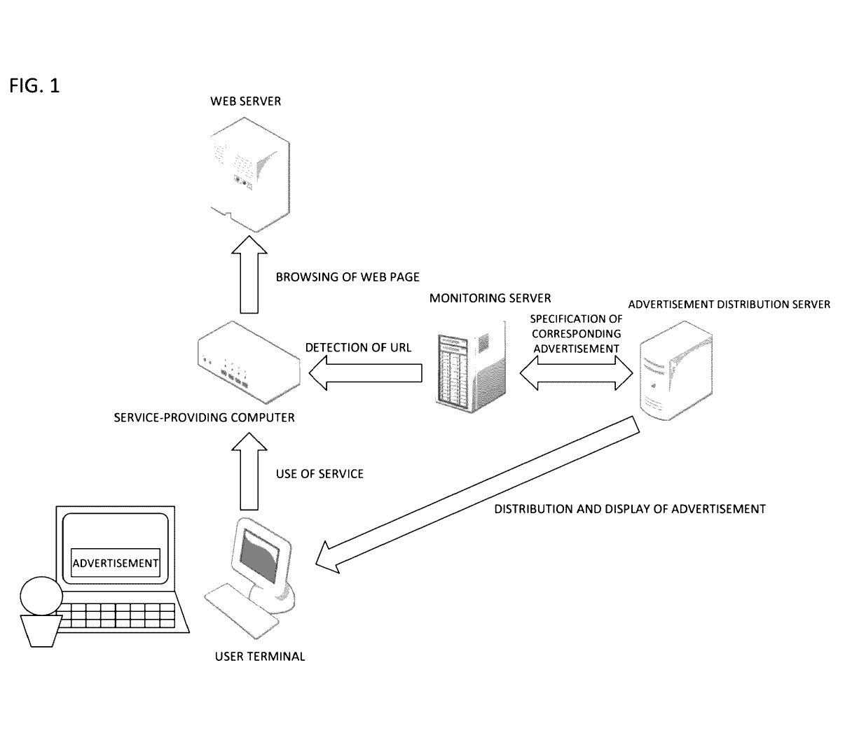

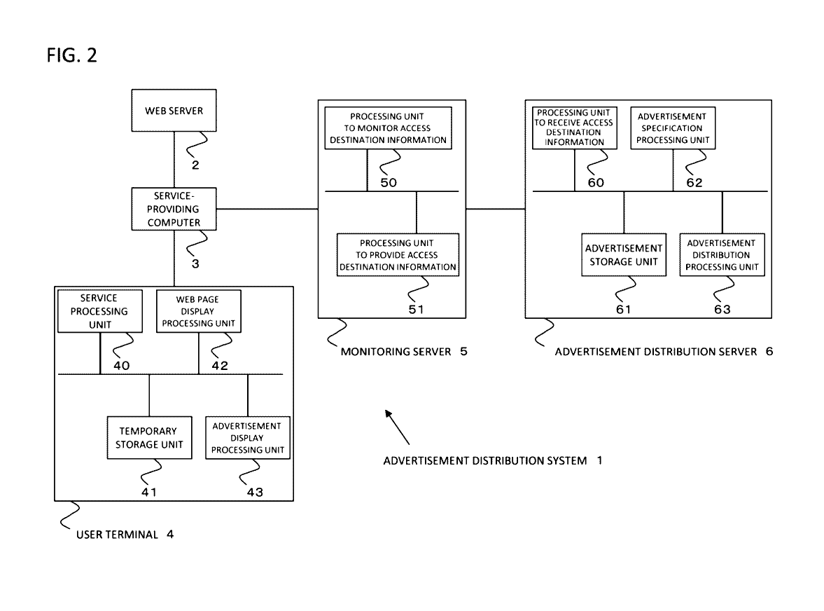

FIG. 1 illustrates an example of the basic concept of an advertisement distribution system 1 according to the present invention. In addition, FIG. 2 illustrates a conceptual diagram of an example of the system configuration of the advertisement distribution system 1.

The advertisement distribution system 1 uses a web server 2, a service providing computer 3, a user terminal 4, a monitoring server 5, and an advertisement distribution server 6. The web server 2 provides a web page to the user terminal 4 which is a computer being used by a user. The service providing computer 3 provides a predetermined service to the user terminal 4. The monitoring server 5 monitors access to the web server 2 and a web page accessed by the user terminal 4. The advertisement distribution server 6 distributes a corresponding advertisement to the user terminal 4 based on information on an access destination (access destination information) when detecting the access as a result of monitoring.

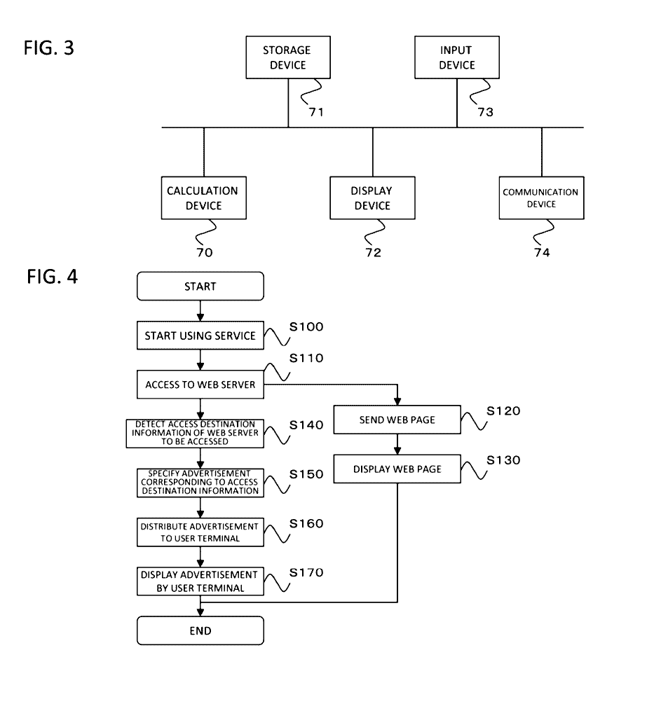

Examples of a computer used in the advertisement distribution system 1 according to the present invention include a server, a personal computer, a cell phone, a PHS, and a tablet type computer. FIG. 3 illustrates an example of a hardware configuration of a general computer. In the case where the web server 2, the service providing computer 3, the user terminal 4, the monitoring server 5, the advertisement distribution server 6 in the advertisement distribution system 1 are a general computer, the computer includes a calculation device 70, a storage device 71, a display device 72 such as a display, an input device 73 such as a key board and a pointing device (a mouse and a numeric keypad), and a communication device 74. The calculation device 70, such as a CPU, performs calculation processing of a program. The storage device 71, such as a RAM and a hard disk, stores information. The communication device 74 sends and receives a processing result of the calculation device 70 and information stored in the storage device 71 via a network such as the Internet and a LAN.

FIGS. 1 and 2 illustrate the case where one computer is provided in each type. However, the function may be realized by distributedly arranging in multiple computers. In each means according to the present invention, the function is logically classified, and the function may be physically or practically formed in a same region.

The web server 2 is a server to send and display a web page to the user terminal 4.

The service providing computer 3 is a computer to be used to provide each type of Internet services to the user terminal 4. Examples of the Internet services include an each type information providing service and a membership service in addition to a service for performing a synchronous processing in a net meeting and among computers. Further, the service providing computer 3 includes a router.

The user terminal 4 includes a service processing unit 40, a temporary storage unit 41, a web page display processing unit 42, and an advertisement display processing unit 43.

The service processing unit 40 performs processing regarding an Internet service provided by the service providing computer 3. For example, in the case where the Internet service is a net meeting system, processing on the user terminal 4 side regarding the system is performed. Examples of processing on the user terminal 4 side include processing regarding network connection between the service providing computer 3 and other computers, transmission and reception of moving image information, transmission and reception of voice information, and file transmission and reception. Further, in the case of a system for performing synchronous processing between computers, examples of processing on the user terminal 4 side include processing regarding network connection with the service providing computer 3 and other computers, processing for obtaining a web page from the web server 2 and storing the web page in the temporary storage unit 41, and processing for causing a partner computer in synchronization to obtain and display information on the web page stored in the temporary storage unit 41.

Processing in the service processing unit 40 at least performs processing corresponding to an Internet service provided by the service providing computer 3 and is not limited to the above each processing.

The temporary storage unit 41 is an information storage unit to temporarily store information on a web page obtained from the web server 2 and information on an advertisement obtained from the advertisement distribution server 6. For example, cache is included in an example of the temporary storage unit 41, but not limited thereto.

The web page display processing unit 42 displays information on a webpage obtained from the web server 2 on a browser displayed by the display device 72 of the user terminal 4.

The advertisement display processing unit 43 displays advertisement information obtained from the advertisement distribution server 6 and stored in the temporary storage unit 41 by superimposing on a web page or at an arbitrary portion in the display device 72 of the user terminal 4.

Advertisement information to be displayed on the advertisement display processing unit 43 is displayed on a browser window independent from a browser window displaying a web page. In addition, on a layer which is at least one layer higher than a browser, advertisement information may be displayed by superimposing on the web page displayed by the browser.

The advertisement distribution system 1 according to the present invention displays advertisement information on a browser window independent from a browser window displaying a web page or displays the advertisement information by superimposing on an original advertisement. Therefore, it is preferable that approval information for displaying the advertisement information is previously received from users, and the advertisement information is displayed to users who have registered the approval information.

The monitoring server 5 monitors the state of access to the web server 2 of each user terminal 4 in the service providing computer 3 and obtains access destination information of the accessed web server 2. Examples of the access destination information include a website, URL of a web page, a company name, a product, a service name, and also any information indicating an access destination, but are not limited thereto.

The monitoring server 5 includes an access destination information monitoring unit 50 and a processing unit to provide access destination information 51.

The access destination information monitoring unit 50 monitors the state of access to the web server 2 of each user terminal 4 in the service providing computer 3 and obtains access destination information of the accessed web server 2 when detecting access to the web server 2.

The processing unit to provide access destination information 51 supplies, to the advertisement distribution server 6, access destination information obtained by the access destination information monitoring unit 50 and information identifying the user terminal 4 (in addition to a user name and an user ID, such as an IP address to be used when the advertisement distribution server 6 distributes advertisement information to the user terminal 4).

The advertisement distribution server 6 distributes corresponding advertisement information to the user terminal 4 based on the access destination information received from the monitoring server 5. The advertisement distribution server 6 includes a processing unit to receive access destination information 60, an advertisement storage unit 61, an advertisement specification processing unit 62, and an advertisement distribution processing unit 63.

The processing unit to receive access destination information 60 receives access destination information sent from the monitoring server 5 and information for identifying the user terminal 4.

The advertisement storage unit 61 stores access destination information and advertisement information in association with each other. FIG. 5 schematically illustrates an example of the advertisement storage unit 61.

The advertisement specification processing unit 62 specifies corresponding advertisement information from the advertisement storage unit 61 based on the access destination information received by the processing unit to receive access destination information 60.

An advertisement distribution processing unit 63 extracts the advertisement information specified by the advertisement specification processing unit 62 from the advertisement storage unit 61 and distributes the advertisement information to the user terminal 4 based on information for identifying the user terminal 4 received by the processing unit to receive access destination information 60. As a result, advertisement display processing is performed by the display device 72 of the user terminal 4 which has received advertisement information. In the case where advertisement information is displayed at a predetermined position, information indicating a display position, for example, coordinate information in the display device 72, is preferably distributed together.

### First Example

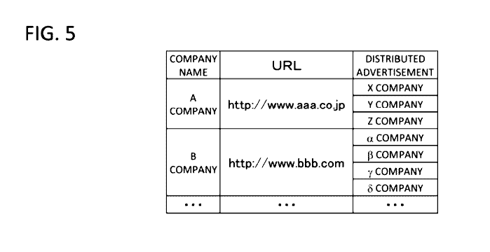

Processing of the advertisement distribution system 1 according to the present invention will be described next with reference to a flowchart illustrated in FIG. 4.

A user of the user terminal 4 performs processing to start using a service by operating a predetermined operation. When the operation is received by the service processing unit 40 of the user terminal 4 (S100), the service processing unit 40 requests to provide service processing to the service providing computer 3.

The service providing computer 3 which has received this request performs service processing to the user terminal 4.

In the case where the user terminal 4 performs operation to browse a web page, the service processing unit 40 sends a request to browse the web page to the service providing computer 3. In the case where the web page browsing request is sent to the web server 2 from the service providing computer 3 or the user terminal 4 (S110), the web server 2 sends information on the web page corresponding to the browsing request to the user terminal 4 (S120). As the browsing request, information on an access destination, such as URL, a company name, a web site name, a product name, or a service name is included.

Then, when the user terminal 4 obtains information on the web page, the information is stored in the temporary storage unit 41, and the web page display processing unit 42 displays the web page information on the display device 72 of the user terminal 4 (S130).

On the other hand, in parallel with the above-described processing, the access destination information monitoring unit 50 of the monitoring server 5 monitors a request from each user terminal 4 in the service providing computer 3. When detecting access to the web server 2 (S140), as access information, the processing unit obtains access destination information and information to identify the user terminal 4 which has accessed.

For example, if the access destination information is “http://www.aaa.co.jp”, and the information to identify the user terminal 4 which has accessed is “a user terminal 41 (IP address: 192.168.ooo.ooo), the access destination information monitoring unit 50 obtains such information. The processing unit to provide access destination information 51 supplies the obtained information to the advertisement distribution server 6.

The processing unit to receive access destination information 60 of the advertisement distribution server 6 receives the access destination information and the information to identify the user terminal 4 supplied from the monitoring server 5. The advertisement specification processing unit 62 specifies a corresponding advertisement based on the access destination information from the advertisement storage unit 61 (S150). In the case of the advertisement storage unit 61 described in FIG. 5, access destination information is “http://www.aaa.co.jp”, and as a distribution advertisement corresponding to the access destination information, any one of or a plurality of advertisements is specified from advertisements of “X Company”, “Y Company”, and “Z Company” in accordance with predetermined conditions. The predetermined conditions may be sequentially or randomly selected, or specified by weighting a ratio of an advertisement rate. In such a case, an occupation ratio of each advertisement rate of “X Company”, “Y Company”, and “Z Company” in the total advertisement ratio is calculated, and the ratio selected based on the calculation may be changed.

For example, if the advertisement rate of “X Company” is “100 thousand yen”, the advertisement rate of “Y Company” is “30 thousand yen”, and the advertisement rate of “Z Company” is 20 thousand yen, a ratio of “X company” is “2/3”, a ratio of “Y Company” is “1/5”, and ratio of “Z Company” is “2/15”. A ratio to select an advertisement of each company preferably corresponds to these ratios.

Here, for example, the advertisement specification processing unit 62 specifies an advertisement of “X Company”. In such a case, the advertisement distribution processing unit 63 distributes advertisement information of specified “X Company” to the user terminal 4 based on information to identify the user terminal 4 received by the processing unit to receive access destination information 60 (S160). In the case of the above-described example, advertisement information of “X Company” is distributed to the IP address, “192.168.ooo.ooo”. Then, when advertisement information sent from the advertisement distribution server 6 is stored in the temporary storage unit 41, the advertisement display processing unit 43 of the user terminal 4 displays the advertisement information on the display device 72 of the user terminal 4 (S170). In the case where information indicating a display position is included as the advertisement information, the advertisement information is displayed at the display position. If the display position is not included, the advertisement information is displayed at an arbitrary position.

By performing the above processing, an advertisement can be distributed without liking the web server 2 and the advertisement distribution server 6. In addition, an advertisement can be distributed without being restricted by advertisement distribution conditions of a website and the web server 2. Therefore, for example, an advertisement of “X Company” can be displayed on a web page of “A Company”.

### Second Example

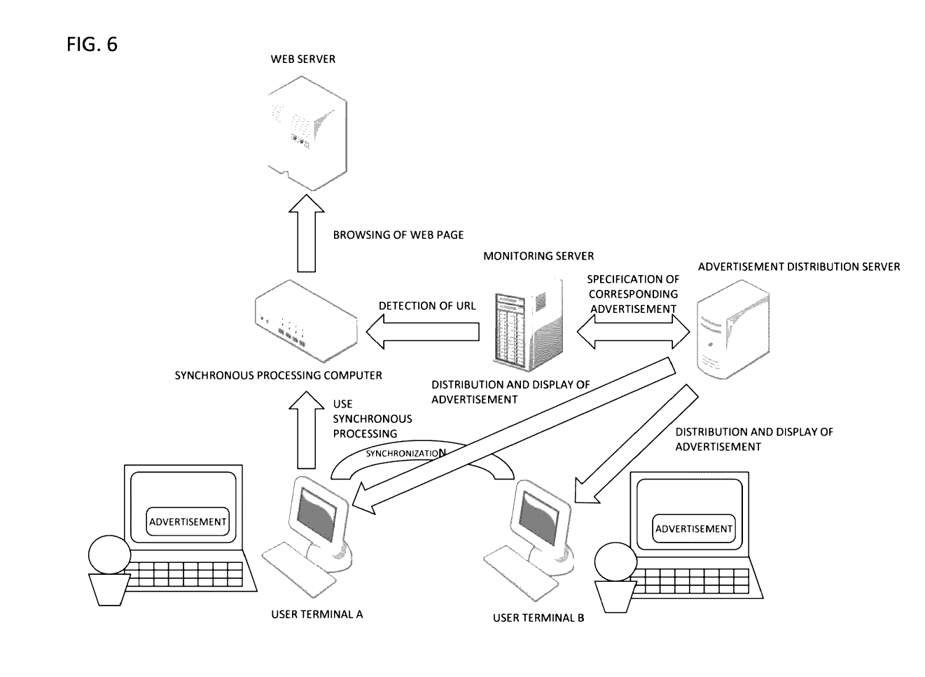

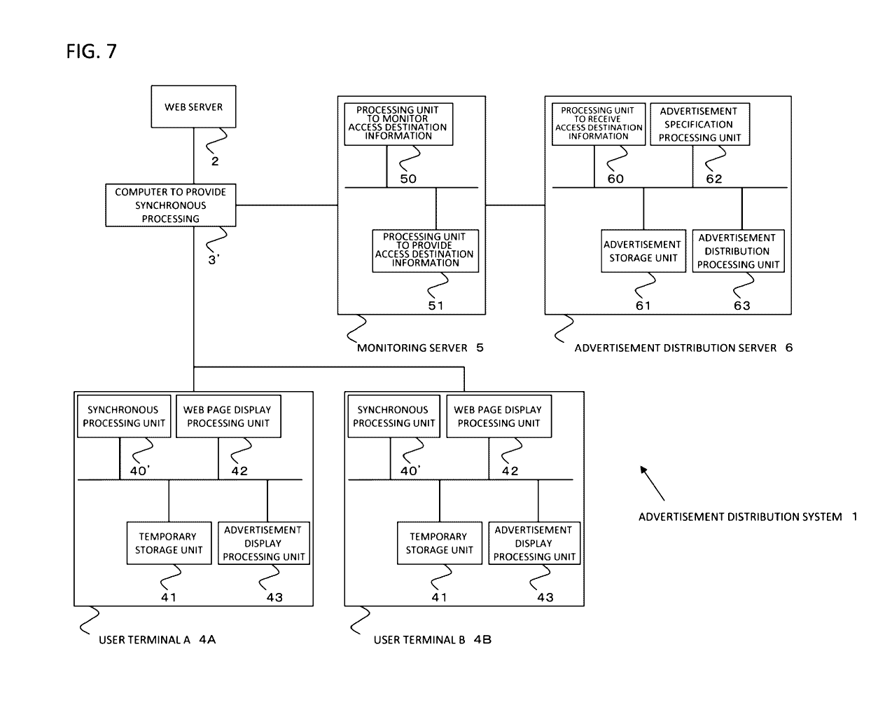

Next, the case will be described where a same advertisement is distributed to a plurality of user terminals 4 in the case where a same web page is displayed by synchronizing the user terminals 4. FIG. 6 illustrates an example of a basic concept of an advertisement distribution system 1 according to a second example. In addition, FIG. 7 illustrates a conceptual diagram of an example of a system configuration of the advertisement distribution system 1.

The advertisement distribution system 1 according to the second example includes a computer to provide synchronous processing 3′ and a synchronous processing unit 40′ as an example of the service providing computer 3 and the service processing unit 40 according to the first example.

The computer to provide synchronous processing 3′ is a computer which receives a connection request from the synchronous processing unit 40′ of each user terminal 4 and establishes a session between the user terminals 4 after each of the user terminals 4 logs in. Further, the synchronous processing unit 40′ performs synchronous processing between the user terminals 4 in which the session has been established. Processing in the computer to provide synchronous processing 3′ and the synchronous processing unit 40′ is realized as described below. As a computer which performs the synchronous processing, a user terminal 4A and a user terminal 4B will be described. In addition, in the description below, two computers (one computer is provided on a host side to be described later, and another computer is provided on a remote side) perform the synchronous processing. However, a plurality of the user terminals 4 may be provided on the remote side.

The user terminal 4 on the host side and the user terminal 4 on the remote side perform the synchronous processing. The user terminal 4 on the host side obtains information on a web page by accessing a web server 2 and stores the information in a temporary storage unit 41. Then, the user terminal 4 on the host side displays the information on the web page. Further, to the user terminal 4 on the remote side, a content update event is notified which indicates that information on a displayed web page is updated and stored in the temporary storage unit 41. When receiving the content update event, the user terminal 4 on the remote side obtains the information on the web page stored in the temporary storage unit 41 of the user terminal 4 on the host side, stores the information in the temporary storage unit 41 of the user terminal 4 on the remote side, and displays the sent web page information.

The temporary storage unit 41 of the user terminal 4 on the host side stores skeleton information on HTML as information on a web page. Regarding image information and text information, as with the user terminal 4 on the host side, the user terminal 4 on the remote side may obtain by accessing the web server 2. When all of web page information is sent to the user terminal 4 on the remote side from the user terminal 4 on the host side, the information is once uploaded from the user terminal 4 on the host side and downloaded to the user terminal 4 on the remote side. Therefore, disadvantage such as a communication time for uploading and a delay in a processing time can be solved. The skeleton information on HTML includes format information on a web page other than content information such as image information, text information, and sound information on the web page.

Each user of the user terminal 4A and the user terminal 4B specifies the computer to provide synchronous processing 3′ to be logged in from a predetermined login screen (not illustrated), and also logs in the computer to provide synchronous processing 3′ by inputting authentication information such as a user name and a password.

In the case where a plurality of the computers to provide synchronous processing 3′ having a different address are provided on a network, each user terminal may log in an arbitrary compute to provide synchronous processing 3′.

After login, each user searches and selects a terminal to be synchronized with own terminal. In this case, automatically, a terminal which requests synchronization is specified to a host-side terminal, and a requested terminal is specified to a remote-side terminal. Terminals specified to the host side and the remote side may be selected. The user terminal 4A or the user terminal 4B establishes a session and selects a partner computer in synchronous processing, and the session between the user terminal 4A and the user terminal 4B is established. For example, the session is established by setting the user terminal 4A to the host side and the user terminal 4B to the remote side.

When the session is established in this manner, the synchronous processing between the user terminal 4A and the user terminal 4B can be performed.

In the case where the user terminal 4A on the host side requests to browse a web page, the user terminal 4A accesses the web server 2 to obtain information on the web page and stores a part of (skeleton information on HTML) or all of the information in the temporary storage unit 41. Then, the user terminal 4A displays the information on the web page. Further, a content update event indicating that the information on the web page is stored in the temporary storage unit 41 is notified to the user terminal 4B on the remote side. When receiving the content update event, the user terminal 4B obtains a part of (skeleton information on HTML) or all of the web page information stored in the temporary storage unit 41 of the user terminal 4A, stores the information in the temporary storage unit 41 of the user terminal 4B, and displays the sent web page information. In this case, if the user terminal 4B obtains all of the web page information, the user terminal 4B displays the web page information obtained from the user terminal 4A. On the other hand, if the user terminal 4B obtains a part of the web page information, for example, skeleton information on HTML, the user terminal 4B accesses the web server 2 of the web page, obtains image information and text information on the web page, and stores the information in the temporary storage unit 41 of the user terminal 4B. Based on the information, the user terminal 4B displays the web page information.

On the other hand, in the case where the user terminal 4B requests to browse a web page, when the user terminal 4B receives a browsing request on the web page, the user terminal 4B determines whether the temporary storage unit 41 of the user terminal 4B stores information on the web page. If the information is not stored, the user terminal 4B sends a request to browse the web page to the user terminal 4A. The user terminal 4A which has received the browsing request determines whether the web page is stored in the temporary storage unit 41 of the user terminal 4A. If the web page is not stored, the user terminal 4A obtains information on the web page from the web server 2 via the computer to provide synchronous processing 3′, stores a part of (skeleton information on HTML) and all of the information in the temporary storage unit 41, and displays the information on the display device 72 of the user terminal 4A. Accordingly, a content update event is notified to the user terminal 4B. The user terminal 4B which has received the content update event obtains a part of (skeleton information on HTML) or all of information on the web page stored in the temporary storage unit 41 of the user terminal 4A, stores the information in the temporary storage unit 41 of the user terminal 4B, and displays the information on the user terminal 4B. In this case, if the user terminal 4B obtains all of the web page information, the user terminal 4B displays the web page information obtained from the user terminal 4A. On the other hand, if the user terminal 4B obtains a part of the web page information, for example, skeleton information on HTML, the user terminal 4B accesses the web server 2 of the web page, obtains image information and text information on the web page, and stores the information in the temporary storage unit 41 of the user terminal 4B. Based on the information, the user terminal 4B displays the web page information.

By performing the above-described synchronous processing, the user terminal 4 to be set on the host side obtains web page information from the web server 2, the information is reflected to the user terminal 4 to be set on the remote side, and display synchronization on the web page is realized.

The access destination information monitoring unit 50 of the monitoring server 5 monitors the computer to provide synchronous processing 3′ and obtains access destination information of the web server 2 accessed by the user terminal 4A and identification information of the user terminal 4. In this case, in addition to the identification information of the user terminal 4A, identification information of the user terminal 4B is obtained. Identification information of the user terminal 4A and the user terminal 4B can be obtained based on a session established between the terminals by the computer to provide synchronous processing 3′.

In this manner, the processing unit to provide access destination information 51 which has obtained access destination information and identification information of the user terminals 4A and 48 supplies the information to the advertisement distribution server 6. When the processing unit to receive access destination information 60 of the advertisement distribution server 6 receives the information, the advertisement specification processing unit 62 specifies advertisement information corresponding to the access destination information based on the advertisement storage unit 61. Then, the advertisement distribution processing unit 63 distributes each advertisement information based on the identification information of the user terminals 4A and 48 received by the processing unit to receive access destination information 60.

The advertisement display processing unit 43 of the user terminal 4A and the advertisement display processing unit 43 of the user terminal 4B receive advertisement information distributed from the advertisement distribution server 6 and display the information on the display devices 72 of the user terminals 4A and 48, respectively.

By performing the above-described processing, same advertisement information can be displayed between computers in which synchronous processing is performed.

### INDUSTRIAL APPLICABILITY

With a configuration as with the advertisement distribution system 1 according to the present invention, an advertisement can be distributed even if a website (web server 2) and the advertisement distribution server 6 are not linked. Therefore, it is not necessary to integrate an advertisement column of a web page and an advertisement. Consequently, an advertisement can be distributed without being restricted by advertisement distribution conditions of a website and a web page. For example, on an advertisement column provided on a web page of a car manufacture, an advertisement of a competitive car manufacture can be displayed.

In addition, even in the case of using a system enabling browsing a same web page while synchronizing multiple computers, a same advertisement can be displayed in multiple computers.

### REFERENCE SIGNS LIST

1 advertisement distribution system
2 web server
3 service providing computer
3′ computer to provide synchronous processing
4 user terminal
5 monitoring server
6 advertisement distribution server
40 service processing unit
40′ synchronous processing unit
41 temporary storage unit
42 web page display processing unit
43 advertisement display processing unit
50 access destination information monitoring unit
51 processing unit to provide access destination information
60 processing unit to receive access destination information
61 advertisement storage unit
62 advertisement specification processing unit
63 advertisement distribution processing unit
70 calculation device
71 storage device
72 display device
73 input device
74 communication device

1. An advertisement distribution system distributing advertisement information to a user terminal being used by a user,
the advertisement distribution system, comprising:
an access destination information monitoring unit, configured to monitor the state of access to a web server of the user terminal in a service providing computer to provide an Internet service to the user terminal and to obtain access destination information and identification information of the user terminal when detecting access to the web server;
an advertisement storage unit configured to store access destination information and advertisement information in association with each other;
an advertisement specification processing unit configured to specify corresponding advertisement information from the advertisement storage unit based on the obtained access destination information; and
an advertisement distribution processing unit configured to distribute the specified advertisement information to the user terminal and cause the user terminal to display the specified advertisement information, based on the obtained identification information of the user terminal.

2. The advertisement distribution system according to claim 1, wherein the user terminal comprises:
a web page display processing unit configured to display information on a web page obtained from the web server; and
an advertisement display processing unit configured to display the distributed advertisement information by superimposing on the web page.

3. The advertisement distribution system according to claim 2, wherein the advertisement display processing unit displays the advertisement information on a browser window independent from a browser window displaying the information on the web page.

4. An advertisement distribution system distributing same advertisement information to each of synchronized user terminals when a plurality of user terminals displays a web page of a web server by synchronizing with each other,
the advertisement distribution system, comprising;
a computer to provide synchronous processing, configured to establish a session between user terminals being used by users;
an access destination information monitoring unit, configured to monitor the state of access to a web server of the user terminal in the computer to provide synchronous processing and to obtain access destination information and identification information on each of the synchronized user terminals when detecting access to the web server;
an advertisement storage unit configured to store access destination information and advertisement information in association with each other;
an advertisement specification processing unit configured to specify corresponding advertisement information from the advertisement storage unit based on the obtained access destination information; and
an advertisement distribution processing unit configured to distribute the specified advertisement information to each of the synchronized user terminals and cause the user terminals to display the specified advertisement information based on the obtained identification information of each of the user terminals.

5. The advertisement distribution system according to claim 4, wherein the user terminal comprises:
a synchronous processing unit configured to perform synchronous processing of a web page between the user terminal and another user terminal by establishing a session with the computer to provide synchronous processing;
a temporary storage unit configured to store information on the web page;
a web page display processing unit configured to display the information on the web page stored in the temporary storage unit; and
an advertisement display processing unit configured to display the distributed advertisement information by superimposing on the web page.

6. The advertisement distribution system according to claim 5, wherein, in a case where the user terminal is selected as a user terminal on a host side, when receiving a request to browse a web page which is not stored in the temporary storage unit, the synchronous processing unit obtains information on a web page corresponding to the browsing request from the web server and stores a part of or all of the information in the temporary storage unit; and
when a part of or all of the information on the web page is stored in the temporary storage unit, by sending a content update event to a user terminal on a remote side, the synchronous processing unit causes the user terminal on the remote side to obtain a part of or all of the information on the web page stored in the temporary storage unit and to display web page information between the user terminal on the host side and the user terminal on the remote side by synchronizing with each other.

7. The advertisement distribution system according to claim 5, wherein, in a case where the user terminal is selected as a user terminal on a remote side, when receiving a request to browse a web page which is not stored in a temporary storage unit on the remote side, the synchronous processing unit sends a request to browse the web page to a user terminal on a host side and causes the user terminal on the host side to determine whether information on the web page is stored in the temporary storage unit of the user terminal on the host side, and if the information is not stored, the synchronous processing unit receives a content update event by causing the user terminal on the host sides to obtain information on a web page corresponding to the browsing request from the web server and to store the information in the temporary storage unit of the user terminal on the host side, and
when receiving the content update event, the synchronous processing unit obtains the information on the web page from the temporary storage unit of the user terminal on the host side and causes the temporary storage unit on the remote side to store the information.

8. The advertisement distribution system according to claim 5, wherein, in a case where the user terminal is selected as a user terminal on a remote side, when receiving a request to browse a web page which is not stored in a temporary storage unit on the remote side, the synchronous processing unit sends a request to browse the web page to a user terminal on a host side and causes the user terminal on the host side to determine whether a part of the information on the web page is stored in the temporary storage unit of the user terminal on the host side, and if the information is not stored, the synchronous processing unit receives a content update event by causing the user terminal on the host sides to obtain information on a web page corresponding to the browsing request from the web server and to store the information on a part of the web page in the temporary storage unit of the user terminal on the host side, and
when receiving the content update event, the synchronous processing unit obtains the information on a part of the web page from the temporary storage unit of the user terminal on the host side and causes the temporary storage unit on the remote side to store the information, and
the synchronous processing unit obtains information other than the information of a part of the web page from the web server and causes the temporary storage unit on the remote side to store the information.

9. An advertisement distribution program, wherein a computer functions as:
an access destination information monitoring unit, configured to monitor the state of access to a web server of the user terminal in a service providing computer to provide an Internet service to a user terminal being used by a user and to obtain access destination information and identification information of the user terminal when detecting access to the web server;
an advertisement specification processing unit configured to specify corresponding advertisement information from an advertisement storage unit to store the access information and the advertisement information in association with each other based on the obtained access destination information; and
an advertisement distribution processing unit configured to distribute the specified advertisement information to the user terminal and cause the user terminal to display the information, based on the obtained identification information of the user terminal.

10. An advertisement distribution program, wherein a computer functions as:
an access destination information monitoring unit, configured to monitor the state of access to a web server of the user terminal in a computer to provide synchronous processing which establishes a session between user terminals being used by users and to obtain access destination information and identification information of each of synchronized user terminals when detecting access to the web server;
an advertisement specification processing unit configured to specify corresponding advertisement information from an advertisement storage unit to store the access information and the advertisement information in association with each other based on the obtained access destination information; and
an advertisement distribution processing unit configured to distribute the specified advertisement information to each of the synchronized user terminals and cause the user terminal to display the information, based on the obtained identification information of each user terminal.

11. The advertisement distribution system according to claim 6, wherein, in a case where the user terminal is selected as a user terminal on a remote side, when receiving a request to browse a web page which is not stored in a temporary storage unit on the remote side, the synchronous processing unit sends a request to browse the web page to a user terminal on a host side and causes the user terminal on the host side to determine whether information on the web page is stored in the temporary storage unit of the user terminal on the host side, and if the information is not stored, the synchronous processing unit receives a content update event by causing the user terminal on the host sides to obtain information on a web page corresponding to the browsing request from the web server and to store the information in the temporary storage unit of the user terminal on the host side, and
when receiving the content update event, the synchronous processing unit obtains the information on the web page from the temporary storage unit of the user terminal on the host side and causes the temporary storage unit on the remote side to store the information.

12. The advertisement distribution system according to claim 6, wherein, in a case where the user terminal is selected as a user terminal on a remote side, when receiving a request to browse a web page which is not stored in a temporary storage unit on the remote side, the synchronous processing unit sends a request to browse the web page to a user terminal on a host side and causes the user terminal on the host side to determine whether a part of the information on the web page is stored in the temporary storage unit of the user terminal on the host side, and if the information is not stored, the synchronous processing unit receives a content update event by causing the user terminal on the host sides to obtain information on a web page corresponding to the browsing request from the web server and to store the information on a part of the web page in the temporary storage unit of the user terminal on the host side, and
when receiving the content update event, the synchronous processing unit obtains the information on a part of the web page from the temporary storage unit of the user terminal on the host side and causes the temporary storage unit on the remote side to store the information, and
the synchronous processing unit obtains information other than the information of a part of the web page from the web server and causes the temporary storage unit on the remote side to store the information.
